(19) United States
(12) Patent Application Publication
(10) Pub. No.: US 2014/0143254 A1
(43) Pub. Date: May 22, 2014

(54) Category and Attribute Specifications for Product Search Queries

(71) Applicants: Ritendra Datta, Pittsburgh, PA (US); Joshua Yelon, Pittsburgh, PA (US); Thomas Walter Murphy, Pittsburgh, PA (US)

(72) Inventors: Ritendra Datta, Pittsburgh, PA (US); Joshua Yelon, Pittsburgh, PA (US); Thomas Walter Murphy, Pittsburgh, PA (US)

(21) Appl. No.: 13/680,005

(22) Filed: Nov. 16, 2012

(51) Int. Cl. G06F 17/30

(52) U.S. Cl. 707/740; 707/E17.089

(57) ABSTRACT

Systems and methods can determine categories for product searches. One or more computing devices can receive a product query of search terms. The product query can be classified to identify a product category. The search terms may be verified against an ambiguous term list for the product category. The search terms may also be verified against an attribute list for the product category. The product query may be classified as fully understood in response to all of the search terms matching either the ambiguous term list or the attribute list for the product category. A product search may be performed on the product query. The product search may be informed by the product category when the product query has been classified as fully understood. Search results may be generated and returned according to the product search.

### TECHNICAL FIELD

The present disclosure relates to systems and methods for determining category and attribute specifications for product search queries.

### BACKGROUND

Users frequently perform Internet search queries for products being offered for sale. The users often type search queries that implicitly refer to a specific product or a set of products within a category. While such implicit references may often occur, explicit references within search queries are much less frequent.

For example, a search query entered by a user as “50 inch lcd” is clearly intended (implicitly) for the product category of televisions even though the product category is not explicitly included within the search query. There is a need in the art for determining product categories from search queries where categories are merely, or even barely, implied or are ambiguous.

### SUMMARY

In certain example embodiments described herein, methods and systems can determine categories for product searches. One or more computing devices can receive a product query of search terms. The product query can be classified to identify a product category. The search terms may be verified against an ambiguous term list for the product category. The search terms may also be verified against an attribute list for the product category. The product query may be classified as fully understood in response to all of the search terms matching either the ambiguous term list or the attribute list for the product category. A product search may be performed on the product query. The product search may be informed by the product category when the product query has been classified as fully understood. Search results may be generated and returned according to the product search.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an online product search system in accordance with one or more embodiments presented herein.

FIG. 2 is a user interface diagram depicting a browser interface for product queries and search results in accordance with one or more embodiments presented herein.

FIG. 3 is a block flow diagram depicting a method for determining category and attribute specifications for product search queries in accordance with one or more embodiments presented herein.

FIG. 4 is a block diagram depicting a computing machine and a module in accordance with one or more embodiments presented herein.

### DETAILED DESCRIPTION OF EXAMPLE EMBODIMENTS

### Overview

The methods and systems described herein enable determining category and attribute specifications for product search queries. As example search queries, “50 inch lcd,” “50 mm ef lens,” and “1TB Drive,” respectively imply product categories of televisions, camera lens, and hard disk drives. However, these categories are not explicitly included within the queries. In order to serve the most relevant search results, it is helpful to determine attributes and aspects of such product queries. For example, it is helpful to determine that the search query “50 mm ef lens” relates to the product category of camera lenses, and also that the desired focal length is 50 mm and the desired mount type is Canon EF.

When one or more terms within a product search query are left indeterminate, the intent of the query may be incorrectly evaluated thereby preventing determination of a correct set of products to present to the user in the search results. Thus, it is an important challenge to understand each part, or term, of the search query. Such a full understanding can provide confidence that the full intent of the query is determined and that properly matching search results are more likely to be provided.

Using a high-precision query classifier, a search query may be automatically mapped to a product category. Such a mapping may be incorrect or uncertain for some terms within the query. Information from a dictionary of attributes associated with various product categories may be applied to resolve uncertainty from the query classifier in determining the product category. Information from a dictionary of category ambiguous terms may also be applied. Such terms may be ambiguous by themselves, but can be resolved to a specific product category when that resolution is supported by category matching attributes from the attribute dictionary.

According to certain example embodiments, an approach may be applied to resolve uncertainty from the query classifier in determining the product category where the query contains an ambiguous term. Such an ambiguous term may relate to more than one category but may be resolved to a specific product category when that resolution is supported by category matching attributes from the attribute dictionary.

According to other example embodiments, an approach may be applied to resolve uncertainty from the query classifier in determining the product category where the query does not contain any terms indicating a particular product category. In such instances, other terms from the search query may indicate an implied product category.

The two example approaches may be used together with other such category resolution techniques to significantly improve the determination of product categories. A metric for evaluating the confidence in the determination of a product category for a search query is whether or not the terms of the search query have been fully understood. The techniques presented herein can significantly increase the percentage of product search queries that may be fully understood.

The functionality of the various example embodiments will be explained in more detail in the following description, read in conjunction with the figures illustrating the program flow. Turning now to the drawings, in which like numerals indicate like (but not necessarily identical) elements throughout the figures, example embodiments are described in detail.

### Example System Architectures

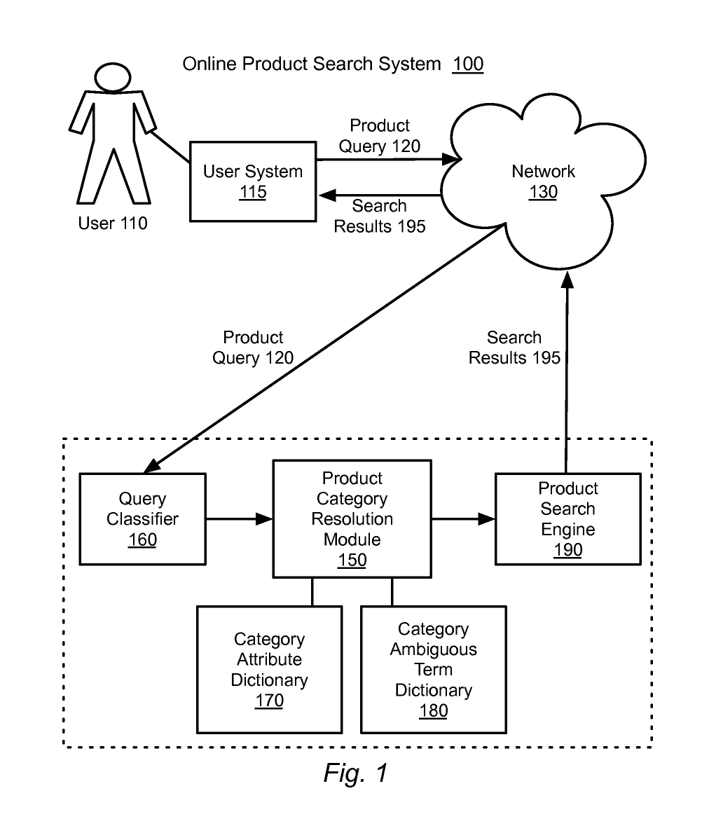

FIG. 1 is a block diagram depicting an online product search system 100 in accordance with one or more embodiments presented herein. Within the online product search system 100, a user 110 can issue a product query 120 from a user system 115 to a query classifier 160 via a network 130. The query classifier 160 can map the query to a product category to be provided to a product category resolution module 150. The product category resolution module 150 can evaluate, correct, and verify the product category determined by the query classifier 160. The product category resolution module 150 may leverage a category attribute dictionary 170 and a category ambiguous term dictionary 180 to improve the resolution of the determined product category. The product query 120 and the determined product category may then be provided to a product search engine 190. The product search engine 190 may then provide search results 195 to the user 110 at the user system 115 via the network 130.

The category attribute dictionary 170 can provide a dictionary of attributes associated with various product categories. The category attribute dictionary 170 may be applied to resolving uncertainty from the query classifier 160 in determining the product category associated with the product query 120. For example, the category attribute dictionary 170 entries associated with the category “camera lenses” may include various focal lengths, various types of lens mounts, and so forth as the attributes associated with products of the category “camera lenses.”

The category ambiguous term dictionary 180 can provide a dictionary of category ambiguous terms. Such terms may be ambiguous by themselves. However, but a product query 120 containing a category ambiguous term may still be resolved to a specific product category according to other terms in the product query 120. For example, the term “lens” may be ambiguous with respect to the product category “camera lenses” since that term may also apply to, among other examples, the category “contact lenses.”

The query classifier 160 may be used to map the product query 120 to an initial product category. Even a high-precision query classifier 160 may return mappings that are incorrect or uncertain for some terms within the product query 120. Accordingly, the product category resolution module 150 may be applied to resolve uncertainty from the query classifier 160 in determining the product category associated with the product query 120.

The product category resolution module 150 can leverage information from the category attribute dictionary 170 and the category ambiguous term dictionary 180 to reduce uncertainty in determining the product category from the product query 120. In practice, the product category resolution module 150 can significantly increase the percentage of product queries 120 that can be fully understand by the online product search system 100.

According to certain example embodiments, uncertainty from the query classifier 160 in determining the product category may be resolved where the product query 120 contains an ambiguous term A. The ambiguous term A may relate to more than one category according to the category ambiguous term dictionary 180. One of those ambiguous categories may be category C. The determination of product category C for the product query 120 may be supported when the other terms from the product query 120 are associated with the category C in the category attribute dictionary 170. In such an instance, the combination of partial evidence from ambiguous term A and the query classification C may be regarded as strong evidence that the product query 120 relates to the determined product category C. The ambiguous term A may be considered properly interpreted when every term other than A in the product query 120 is also understood based on the category attribute dictionary 170 for category C. For example, using the query “50 mm ef lens,” the whole product query 120 may have been classified into the “camera lens” category by the query classifier 120. However, the category ambiguous term dictionary 180 indicates that for the “camera lens” category, the term “lens” is an ambiguous term. According to the category attribute dictionary 170, “50 mm” may relate to a focal length of associated with the “camera lens” product category. Similarly, the query term “ef” may relate to a “Canon EF” mount type for the “camera lens” product category. Together, this accounts for every part of the search query 120 even though one part of it (“lens”) may be ambiguous for the category. Thus, the product query 120 of “50 mm ef lens” may be fully understood as related to the “camera lens” product category. In a contrasting example, the product query 120 of “acuvue lens” contains the same ambiguous term “lens” but may be resolved to the product category “contact lenses” where the category ambiguous term dictionary 180 also includes “lens” as an ambiguous term for the product category “contact lenses.” These examples demonstrate how the term “lens” may be disambiguated based upon context within the product query 120.

According to certain other example embodiments, uncertainty from the query classifier 160 in determining the product category may be resolved where the product query 120 does not contain any terms (even ambiguous terms) indicating a particular product category, however other terms within the product query 120 indicate an implied product category. When every term, or part, of the product query 120 is found within the category attribute dictionary 170 for category C, it is determined as strong corroborative evidence that the classification of category C is correct.

Considering the example product query 120 of “52 inch sony lcd,” the product query 120 may be initially classified into the “television” product category by the query classifier 160. The product category resolution module 150 may leverage the category attribute dictionary 170 to confirm that “52 inch” is a reasonably diagonal dimension for a television, “sony” is a known television brand, and “lcd” is a common television technology. Together, these resolutions from the category attribute dictionary 170 can support a confirmation of the implied product type “television.” In such an instance of an implied product category, it is further strong evidence when no term, or part, of the product query 120 offends the category determination of category C by failing to be resolved within the category attribute dictionary 170 for category C. Such a complete category identification supports characterizing the product query 120 (of “52 inch sony lcd”) as being fully understood.

It may be considered an important challenge to understand each part, or term, or the product query 120. Such a “fully understood” determination can provide confidence that the full intent of the product query 120 is determined and the proper matching search results 195 are more likely to be identified.

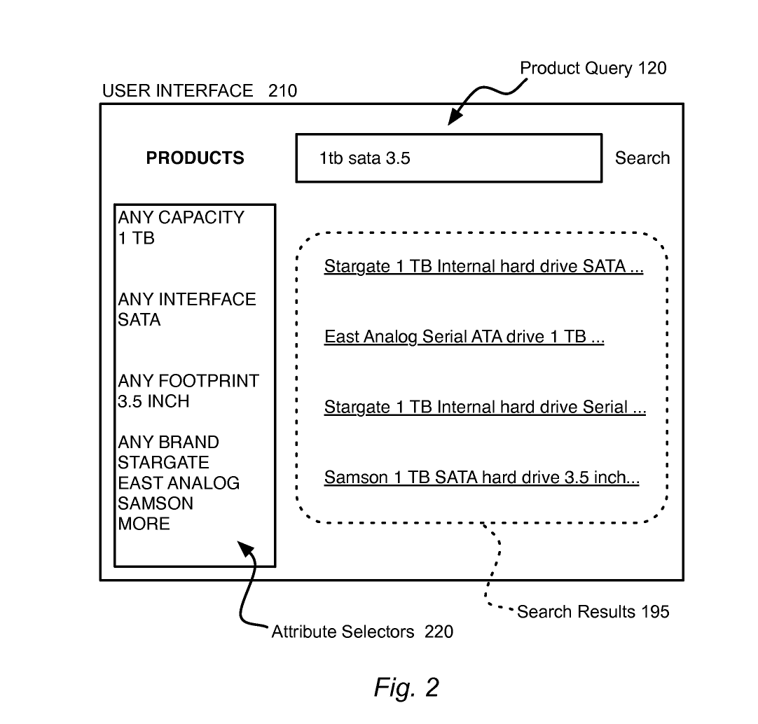

The product search engine 190 can use the product query 120 along with the determined product category associated with the product query 120 to identify search results 195. The product search engine 190 may comprise various search index techniques. The product search engine 190 may also leverage product or shopping search techniques. The search results 195 may be presented to the user 110 at a user system 115 within a web browser or other application software. According to one or more example embodiments, example search results 195 are presented in further detail with respect to FIG. 2.

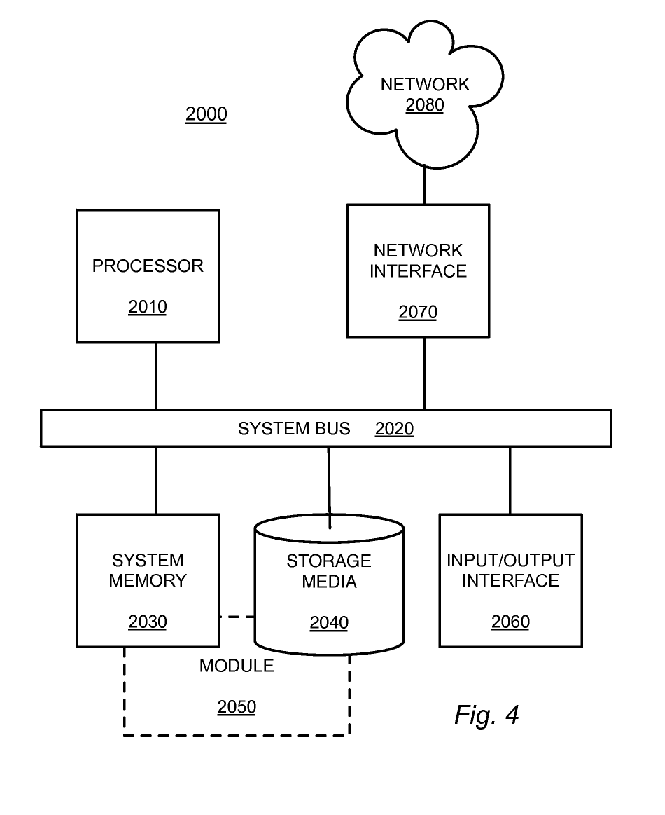

The user system 115, one or more systems associated with the query classifier 160, the product category resolution module 150, the product search engine 190, or any other computing machines associated with this technology may be any type of computing machine such as, but not limited to, those discussed in more detail with respect to FIG. 4. Furthermore, any modules associated with any of these computing machines or any other modules (scripts, web content, software, firmware, or hardware) associated with the technology presented herein may by any of the modules discussed in more detail with respect to FIG. 4. The computing machines discussed herein may communicate with one another as well as other computer machines or communication systems over one or more networks such as network 130. The network 130 may include any type of data or communications network including any of the network technology discussed with respect to FIG. 4.

FIG. 2 is a user interface diagram depicting a browser interface for product queries 120 and search results 195 in accordance with one or more embodiments presented herein. The user interface 210 can provide an input mechanism for the user 110 to enter a product query 120. The user interface 210 can provide a list of search results 195 from the online product search system 100. A set of attribute selectors 220 may be included within the user interface 210 to allow the user 110 to narrow or redirect the search results 195 onto products with specific product attributes.

The user interface 210 may be rendered as content to be presented to a browser or other software application. Such a browser or software application may be configured to execute upon the user system 115. As such, the user interface 210 may be presented to, and/or interacted upon by, the user 110 at a user system 115.

The attribute selectors 220 may be included within the user interface 210 to allow the user 110 to narrow or redirect the search results 195 onto products with specific product attributes. The attributes may be populated within the attribute selectors 220 according to the determined product category for the product query 120. For example, the attributes for population and presentation may be retrieved from the category attribute dictionary 170 according to the determined product category. Presentation of the attribute selectors 220 may be particularly meaningful when the product query 120 has been “fully understood” implying a high confidence that the determined product category corresponds to the product query 120.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

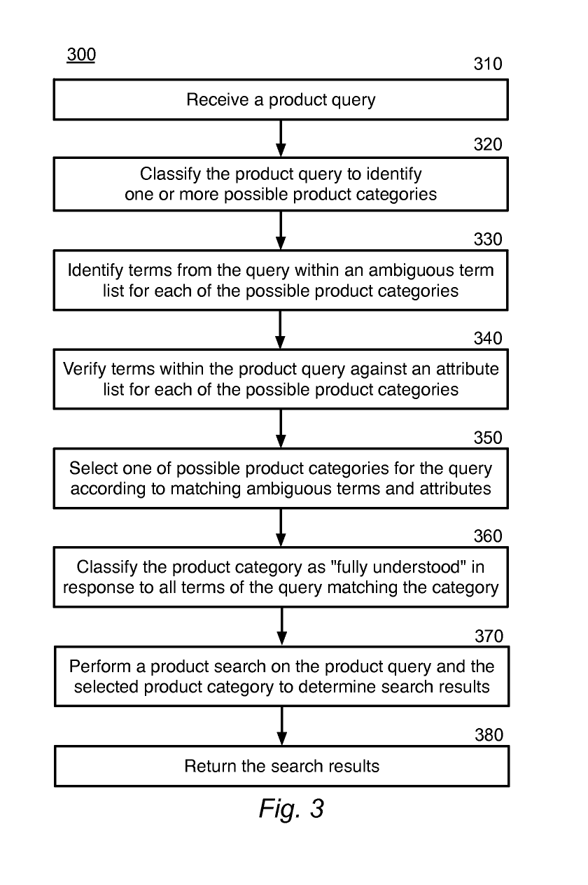

FIG. 3 is a block flow diagram depicting a method 300 for determining category and attribute specifications for product search queries in accordance with certain exemplary embodiments.

In block 310, the online product search system 100 can receive a product query 120 from a user 110 associated with a user system 115. The product query 120 can include terms associated with one or more products being searched by the user 110.

In block 320, a query classifier 160 may be used to map the product query 120 to one or more initial product categories. Generally, the set of search terms making up the product query 120 may be mapped to a category that covers the set of terms. However, the resulting initial product category mappings may be uncertain for some terms within the product query 120. Accordingly, the product category resolution module 150 may be applied to resolve uncertainty from the query classifier 160 in determining the product category associated with the product query 120.

In block 330, the product category resolution module 150 can leverage information from the category ambiguous term dictionary 180 to reduce uncertainty in determining the product category from the product query 120 where the product query 120 contains an ambiguous term. The ambiguous term may relate to more than one category according to the category ambiguous term dictionary 180. However, the determination of the product category for the product query 120 may be supported when the other terms from the product query 120 are in the category attribute dictionary 170 for the particular category determined for the product query 120. In such an instance, the combination of partial evidence from an ambiguous term and the other query terms may be regarded as strong evidence that the product query 120 relates to the determined product category.

In block 340, the product category resolution module 150 can leverage information from the category attribute dictionary 170 in determining the product category from the product query 120. Such implied category resolution can be useful where the product query 120 contains terms implying a product category. Every term, or part, of the product query 120 found within the category attribute dictionary 170 for a particular category, may imply strong corroborative evidence that the classification of that category for the product category 120 is correct. The greater a number of terms within the product query 120 that are within the category attribute dictionary 170 for a particular category strengthen the understanding that the particular category is the correct product category for the product query 120. When ideally every term in the product query 120 is within the category attribute dictionary 170 (or the category ambiguous term dictionary 180) for the particular category then the product query 120 may be classified as “fully understood.”

In block 350, the product category resolution module 150 can select a product category for the product query 120. The product category may be selected for having attributes (according to the category attribute dictionary 170) matching terms, or parts, of the product query 120 along with any arbitrary terms from the product query 120 according to the category ambiguous term dictionary 180. Where more than one of the product categories may be initially identified, a category with the most matches may be preferred. A category that covers all terms, or parts, of the product query 120 in either attributes or matched ambiguous terms may be selected as the category and then also result in the product query 120 to be classified as “fully understood.”

In block 360, the selected product category may be classified as “fully understood” in response to all terms of the query matching the category. Such a “fully understood” determination can provide confidence that the full intent of the product query 120 is determined and the proper matching search results 195 are more likely to be identified. If the search query 120 is not classified as “fully understood,” a best guess category may still be determined.

In block 370, the product search engine 190 can process the product query 120 to identify search results 195. The search engine 190 may also leverage the selected product category to refine the search results 195. For example, the search may be limited to, or narrowed to, products within the identified product category. Also, the search may be limited by the attributes associated with the product category as identified within the product query 120 according to the category attribute dictionary 170. As such the search may be informed by, or improved by, the category determined for the product query 120. According to various example embodiments, refinement or limitation of the search by the product category may be dependent upon whether or not the product query 120 was classified as “fully understood,” or not. According to other example embodiments, application of the product category to the product search may be a function of a confidence metric based upon how well the product query 120 was understood or how many of the search terms match the category attribute dictionary 170 or the category ambiguous term dictionary 180 according to the product category.

In block 380, the online product search system 100 can return search results 195 to the user 110 at a user system 115 via the network 130. The search results 195 may be presented to the user 110 at a user system 115 within a web browser or other application software.

After block 380, the method 300 ends. Of course, the determination of category and attribute specifications for product search queries may be continued through repeated, or continual, application of method 300.

### Example Systems

FIG. 4 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for determining categories for product searches, the method comprising:
receiving, using one or more computing devices, a product query of search terms;
classifying, using the one or more computing devices, the product query to identify a product category;
verifying, using the one or more computing devices, the search terms against an ambiguous term list for the product category;
verifying, using the one or more computing devices, the search terms against an attribute list for the product category;
classifying, using the one or more computing devices, the product query as fully understood for the product category in response to each of the search terms matching either the ambiguous term list for the product category or the attribute list for the product category;
performing, using the one or more computing devices, a product search on the product query;
refining, using the one or more computing devices, the product search by the product category in response to the product query being classified as fully understood; and
returning, using the one or more computing devices, search results according to the product search.

2. The computer-implemented method of claim 1, wherein the ambiguous term list for the product category comprises terms that may also indicate one or more other product categories.

3. The computer-implemented method of claim 1, wherein the attribute list for the product category comprises terms applicable as attributes to one or more products within the product category.

4. The computer-implemented method of claim 1, wherein refining the product search by the product category comprises limiting the product search to products within the product category.

5. The computer-implemented method of claim 1, wherein the search results comprise links to products.

6. The computer-implemented method of claim 1, further comprising generating an attribute selector according to the product category.

7. The computer-implemented method of claim 1, further comprising generating an attribute selector according to the product category and populating the attribute selector according to attributes within the product query.

8. A system, comprising:
one or more computing devices,
wherein the one or more computing devices are configured to:
receive a product query of search terms;
classify the product query to identify a product category;
verify the search terms against an ambiguous term list for the product category;
verify the search terms against an attribute list for the product category;
classify the product query in response to each of the search terms matching either the ambiguous term list for the product category or the attribute list for the product category;
perform a product search on the product query;
refine the product search by the product category in response to the product query being classified; and
return search results according to the product search.

9. The system of claim 8, wherein the ambiguous term list for the product category comprises terms that may also indicate one or more other product categories.

10. The system of claim 8, wherein the attribute list for the product category comprises terms applicable as attributes to one or more products within the product category.

11. The system of claim 8, wherein refining the product search by the product category comprises limiting the product search to products within the product category.

12. The system of claim 8, wherein the search results comprise links to products.

13. The system of claim 8, wherein the one or more computing devices are further configured to generate an attribute selector according to the product category.

14. The system of claim 8, wherein the one or more computing devices are further configured to generate an attribute selector according to the product category and populating the attribute selector according to attributes within the product query.

15. A computer program product, comprising:
a non-transitory computer-readable medium having computer-readable program code embodied therein that, when executed by one or more computing devices, cause the one or more computing devices to perform a method comprising:
receiving, using one or more computing devices, a product query of search terms;
classifying, using one or more computing devices, the product query to identify a product category;
verifying, using one or more computing devices, the search terms against an ambiguous term list for the product category;
verifying, using one or more computing devices, the search terms against an attribute list for the product category;
classifying, using one or more computing devices, the product query as fully understood for the product category in response to each of the search terms matching either the ambiguous term list for the product category or the attribute list for the product category;
performing, using one or more computing devices, a product search on the product query;
refining, using one or more computing devices, the product search by the product category in response to the product query being classified as fully understood; and
returning, using one or more computing devices, search results according to the product search.

16. The computer program product of claim 15, wherein the ambiguous term list for the product category comprises terms that may also indicate one or more other product categories.

17. The computer program product of claim 15, wherein the attribute list for the product category comprises terms applicable as attributes to one or more products within the product category.

18. The computer program product of claim 15, wherein refining the product search by the product category comprises limiting the product search to products within the product category.

19. The computer program product of claim 15, wherein the search results comprise links to products.

20. The computer program product of claim 15, wherein the method further comprises generating an attribute selector according to the product category and populating the attribute selector according to attributes within the product query.
